(19) United States
(12) Patent Application Publication
(10) Pub. No.: US 2026/0178930 A1
(43) Pub. Date: Jun. 25, 2026

(54) FEDERATED LEARNING METHOD AGAINST BACKDOOR ATTACKS

(71) Applicants: HAINAN INSTITUTE OF ZHEJIANG UNIVERSITY, SANYA, HAINAN PROVINCE (CN); ZHEJIANG UNIVERSITY, Hangzhou, ZHEJIANG PROVINCE (CN)

(72) Inventors: SHUIGUANG DENG, HANGZHOU, ZHEJIANG PROVINCE (CN); ZHEN QIN, HANGZHOU, ZHEJIANG PROVINCE (CN); YONG HE, HANGZHOU, ZHEJIANG PROVINCE (CN); CHONGDE SUN, HANGZHOU, ZHEJIANG PROVINCE (CN)

(21) Appl. No.: 18/848,900

(22) PCT Filed: Oct. 10, 2023
(86) PCT No.: PCT/CN2023/123753

§ 371 Date: Sep. 19, 2024

(30) Foreign Application Priority Data
Aug. 22, 2023 (CN) 202311059976.1

(51) Int. Cl. G06N 3/098; G06N 3/0455

(52) U.S. Cl. CPC G06N 3/098; G06N 3/0455

(57) ABSTRACT

Disclosed in the present invention is a federated learning method against backdoor attacks. Firstly, a few benign model updates with high confidences are selected through cluster-based voting, and then the selected model updates are regarded as benign modes of model updates. An anomaly detection method based on a variational autoencoder progressively selects more benign model updates from the remaining candidate model updates, so that the size of a population of the selected benign model updates is continuously expanded. The present invention does not rely on adjustment of differential privacy, weight clipping and a learning rate, and only a minor change is made to an original federated learning protocol, which on the one hand has little impact on the accuracy of the global model, and on the other hand is easy to integrate with an existing federated learning system. Compared with an existing federated learning method against backdoor attacks, the present invention has stronger adaptability.

### FIELD OF TECHNOLOGY

The present invention belongs to the technical field of artificial intelligence, and in particular relates to a federated learning method against backdoor attacks.

### BACKGROUND TECHNOLOGY

Artificial intelligence has become one of important technologies to drive social and economic development, and has been deeply integrated into every corner of people's lives. As a core technology of the artificial intelligence represented by deep learning continues to make new breakthroughs, the artificial intelligence technology gradually relies on a large amount of data for model training, but this has brought about a problem of excessive collection and use of personal privacy data, resulting in people's awareness and concerns about data privacy are also growing. Introduction of data regulatory policies and emergence of related regulatory technologies have promoted a development of privacy-protecting artificial intelligence technology, and promoted a progress of federated learning (FL), which is a computing paradigm that collaborates with a plurality of parties to train a machine learning model under a premise of protecting the data privacy.

Due to the inaccessibility of distributed data, FL is vulnerable to malicious clients, especially backdoor attacks that neither significantly alter the statistical properties of the model like Gaussian noise attacks, nor cause noticeable modifications to the training data like label-flipping attacks, and are therefore more covert to existing defense methods based on model statistics and spectral analysis.

Existing work defends against target attacks in the FL by the following manners: (1) Byzantine robust aggregation [Peva Blanchard, El Mahdi El Mhamdi, Rachid Guerraoui, and Julien Stainer. Machine learning with adversaries: Byzantine tolerant gradient descent. Advances in neural information processing systems, 30, 2017]; (2) Robust learning rate [Mustafa Safa Ozdayi, Murat Kantarcioglu, and Yulia R Gel. Defending against backdoors in federated learning with robust learning rate. In Proceedings of the AAAI Conference on Artificial Intelligence, volume 35, pages 9268-9276, 2021]; (3) Combination of weight clipping, noise superposition, and clustering options [Eugene Bagdasaryan, Andreas Veit, Yiqing Hua, Deborah Estrin, and Vitaly Shmatikov. How to backdoor federated learning. In International Conference on Artificial Intelligence and Statistics, pages 2938-2948. PMLR, 2020]; (4) Provably secure FL that relies on model integration [Chulin Xie, Minghao Chen, Pin-Yu Chen, and Bo Li. CRFL: Certifiably robust federated learning against backdoor attacks. In International Conference on Machine Learning, pages 11372-11382, 2021]; and (5) Anomaly detection [Suyi Li, Yong Cheng, Wei Wang, Yang Liu, and Tianjian Chen. Learning to detect malicious clients for robust federated learning. arXiv preprint arXiv: 2002.00211, 2020]. However, proven safe methods rely on certain assumptions to provide theoretical guarantees, and their performance may be weaker than empirical defenses in reality, because the assumptions may not always be satisfied. Moreover, they rely on a large collection of noisy models, reducing inference efficiency, and do not obtain a single model that can be deployed to a client, and the rest requires a clear boundary of a global perspective between benign and malignant model updates, which usually only occurs in the following conditions: (1) statistical heterogeneity of data is not complicated, that is, independent and identically distributed or simple pathological non-independent and identically distributed, which makes it easy to form different clusters for model updating; and (2) poison data rate (PDR) is relatively high, which makes the malignant model update significantly deviate from the benign model update, for example, the PDR is not less than 50%. Moreover, many defenses are only evaluated on a relatively small number of malicious clients, for example no more than 10% are malicious, in which case the impact of attacks would not be significant even if a malignant model update escapes from a detection. In general, it may be more appropriate to design a federated learning method against backdoor attacks based on an anomaly detection technology that has less impact on the accuracy of a global model. As no noise is introduced, and the aggregation of original federated learning does not change significantly, it maintains a consistent optimization goal. However, there are two main challenges to adopt the anomaly detection technology directly:

Challenge 1 (insufficient benign patterns): each round of benign model updates lacks benign patterns due to the unpredictable distribution and trajectory shift of model updates.

Challenge 2 (unclear boundary): because of little impact on model parameters from the backdoor attacks as well as a data heterogeneity problem faced by the federated learning, the boundary between the benign and malignant model updates is often unclear.

### SUMMARY OF THE INVENTION

In view of the above, the present invention provides a federated learning method against backdoor attacks, which modifies an original federated aggregation algorithm so that instead of directly aggregating all received model updates, a subset of a received model update set is selected for aggregation through two key steps of “cluster-based voting” and “progressive selecting”. Thus, malignant model updates are excluded.

A federated learning method against backdoor attacks, wherein in each round of federated learning, participants first download a global model from a central server, and then use a data set thereof to train and update parameters of a local global model, a parameter difference between an updated local global model and the global model originally downloaded in the round is a model update, and the participants then upload the model update to the central server;

After receiving N model updates, the central server selects, through a cluster-based voting mode, benign model updates from a decentralized perspective when the benign model updates are in the majority, wherein Nis a quantity of the participants in the federated learning;

A differential training set is constructed according to the selected benign model updates and the set is utilized to train a variational auto-encoder;

A differential verification set is constructed, data in the set is reconstructed by the variational auto-encoder, and a population of the selected benign model updates is progressively expanded according to a reconstruction error; and

The central server performs a federated average algorithm on all the selected benign model updates to obtain a global model without a backdoor and distributes the global model to the participants for a next round of federated learning.

Further, the benign model updates refer to model updates obtained by the participants using a data set without an injected trigger for training, whereas model updates obtained by the participants using data set based on the injected trigger for training are malignant model updates.

Further, a specific implementation of mining the benign model updates by the central server is as follows: first, a model update set received by the central server is denoted as [symbol] ={Δw₁, Δw₂, . . . , Δw_{N}}, wherein Δwᵢ is a model update uploaded by an i^{th} participant, and i is a natural number and 1≤i≤N; the global model is assumed as a neural network with L layers, and for an m^{th} layer parameter Δw_{i,m} in a model update Δwᵢ, a zero vector and K−1 model updates farthest from Δw_{i,m} are selected as initial points of a K-means algorithm, and Δw_{i,m} votes for all model updates in a cluster thereof after dividing into clusters, wherein m is a natural number and 1≤m≤L; in this way, each model update votes for L times, each with a weight of 1; and finally, several model updates with a highest vote form a benign model update set with high confidence, denoted as [symbol] .

Further, after obtaining the set [symbol] , the central server first calculates differences between model updates in [symbol] according to a form of Cartesian product, thus forming a differential training set; any difference data in the differential training set is Δwₐ−Δw_{b}, wherein Δwₐ and Δw_{b} are any two different model updates in the set [symbol] ; and then the differential training set is utilized to train a variational auto-encoder, of which an input is any difference data in the differential training set and an output is a vector of the same dimension, and the variational auto-encoder can generate an output that is as similar as possible to the input.

Further, a complementary set of the set [symbol] is taken, that is [symbol] − [symbol] ; any difference data in the differential verification set is Δw_{c}−Δw_{d}, wherein Δw_{c} is any model update in the complementary set, Δw_{d} is any model update in the set [symbol] ; the variational auto-encoder is utilized to reconstruct each piece of difference data in the differential verification set; and several pieces of difference data with a least average reconstruction error are selected, and Δw_{c} in the pieces of difference data is added to the set [symbol] .

Further, the reconstruction error is measured by a mean square error between input data of the variational auto-encoder and reconstruction data.

Further, when a population of benign model updates is expanded, a latest set [symbol] is utilized to update the differential training set and fine-tune the variational auto-encoder for judgment; if the number of sets [symbol] exceeds a preset threshold, the federated averaging algorithm is performed on the sets; and otherwise, the differential verification set is updated with the latest set [symbol] , and the benign model updates are expanded again through reconstruction until the number of model updates contained in sets [symbol] exceeds the preset threshold.

Based on the technical solution, the present invention has the following beneficial technical effects:

1. The present invention enables a federated learning method against backdoor attacks, which does not rely on adjustment of differential privacy, weight clipping and a learning rate, and only a minor change is made to an original federated learning protocol, which on the one hand has little impact on the accuracy of the global model, and on the other hand is easy to integrate with an existing federated learning system.

2. Through the cluster-based voting and progressive selection, the present invention may steadily select a group of benign model updates for aggregation without obvious clustering of benign and malignant model updates to different locations; and compared with an existing federated learning method against backdoor attacks, the present invention has stronger adaptability.

### BRIEF DESCRIPTION OF THE DRAWINGS

FIG. 1 is a schematic diagram of an architecture of a federated learning system against backdoor attacks in the present invention.

FIG. 2 is a schematic flow chart of a federated learning method against backdoor attacks in in a round of federated aggregation in the present invention.

### DESCRIPTION OF THE EMBODIMENTS

In order to describe the present invention more specifically, the technical solution of the present invention is described in detail in combination with the attached drawings and specific embodiments.

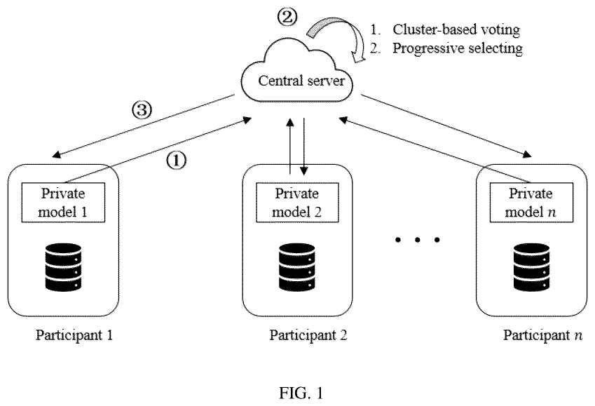

An architecture of a system running a federated learning method against backdoor attacks in the present invention is as shown in FIG. 1. The system mainly comprises a central server and participants. The central server is responsible for coordinating each participant to run the federated learning method, and each participant is responsible for training locally, submitting model updates and receiving an aggregated result from the central server.

In order to benefit from the federated learning system (to obtain a more accurate model) and participate in the federated learning system, terminal devices of the participants upload model parameters to the central server and download aggregated model parameters from the central server. For a federated learning participant, in a round of federated learning, it first downloads a global model, forms a copy of the global model, and then uses its own data set to update parameters of the copy of global model. A parameter difference between an updated global model and the global model downloaded at the beginning of the round is called model update.

A malicious participant (attacker) would inject a trigger into its own data set and update the global model based on training data injected with the trigger, so that the model updates submitted by it enable the global model to recognize the trigger and make a particular error output, and the model updates submitted by the malicious participant are called malignant model updates. Model updates obtained by normal participants using a data set without an injected trigger for training are called benign model updates.

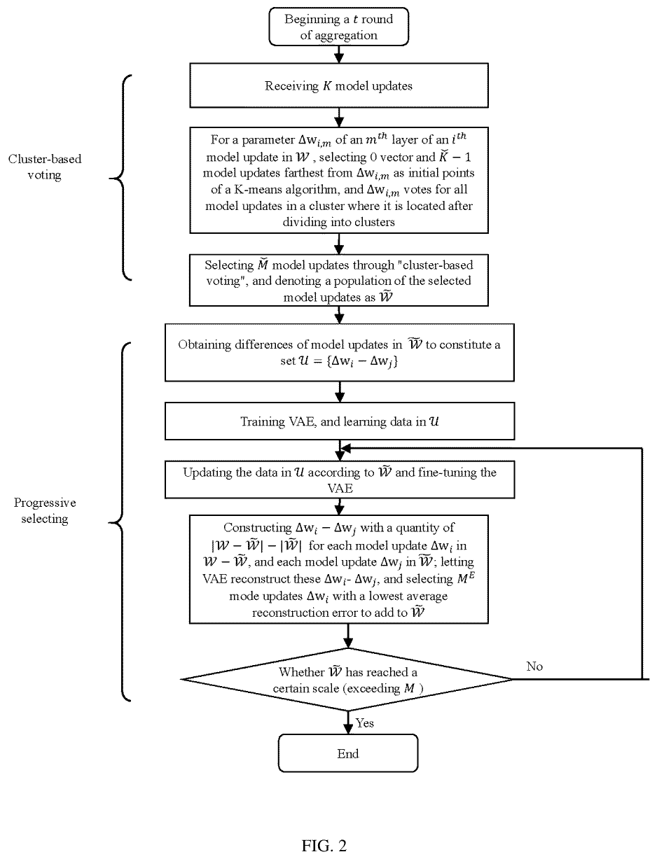

The federated learning method against backdoor attacks in the present invention is executed in each round of federated learning and is used to replace an original federated average algorithm. As shown in FIG. 2, in a round of federated learning, the federated learning method of the present invention begins after the central server receives a number of N model updates (denoted as [symbol] W={Δw₁, Δw₂, . . . , Δw_{K}}, [ [symbol] ]=N), comprising the following steps:

1. Considering that for a particular model update, a model update closer to it is most likely to share its standpoint, that is, if the model update is benign, a few of model updates closest to it tend to be benign as well, and vice versa. Therefore, through voting, benign model updates can be mined from a decentralized perspective when benign model updates account for the majority of N model updates received by the central server in the round.

Assuming that model parameters are neural network with L layers, a parameter Δw_{i,m} of m^{th} layer of i^{th} model update in [symbol] is considered as an intelligent agent with voting rights, which vote in the following way: selecting 0 vector and K−1 model updates farthest from Δw_{i,m} as initial points of a K-means algorithm (K<N), and Δw_{i,m} votes for all model updates in the cluster where it is located after the received N model updates are divided into K clusters. In this way, a total of L votes in each model update Δwᵢ, and a weight of each vote is uniformly set to 1 in this example; the whole voting process is carried out on the central server, which is actually equivalent to making the central server select benign model updates from a perspective of each model update.

2. M̌ model updates with a highest vote are regarded as benign model updates with high confidences, which is denoted as [symbol] ; and the step of “cluster-based voting” ends, wherein M̌<N.

3. The benign model update set [symbol] obtained in the previous step is used as a benign mode of model updates, a difference between every two model updates in [symbol] is obtained with reference to a form of Cartesian product, and all differences between every two model updates in [symbol] constitute a set [symbol] ={Δwᵢ−Δwⱼ}, wherein Δwᵢ and Δwⱼ are any different model updates in [symbol] .

4. A variational auto-encoder (VAE) is trained with data in [symbol] , a goal of the training process is to enable the VAE to have the following function: given data in [symbol] , the VAE can generate an output that is as similar as possible to an original input.

5. According to the newest [symbol] , [symbol] is updated in accordance with the way as described in step 3, and then the VAE is fine-tuned based on the updated [symbol] .

6. For each model update Δwᵢ in a set [symbol] − [symbol] and each model update Δwⱼ in [symbol] [symbol] , | [symbol] − [symbol] |×| [symbol] | model differences Δwᵢ−Δwⱼ are constructed, the model differences are taken as an input of the VAE, the VAE tries to reconstruct the Δwᵢ−Δwⱼ, and \hat{M} model updates Δwᵢ with a least average reconstruction error are selected to add to [symbol] , wherein the reconstruction error can be measured by mean square error (MSE) between original input data and reconstructed data. For each model update Δwᵢ, the average reconstruction error refers to an average value of the reconstruction errors of | [symbol] | model differences related to Δwᵢ in | [symbol] − [symbol] |×| [symbol] | model differences constructed in this step.

7. If the number of updated models in [symbol] exceeds M, step 8 is performed; and otherwise, step 5 is performed.

8. [symbol] is returned.

After the end of the method, the federated average algorithm is performed on the model updates contained in [symbol] to obtain a global model that does not contain backdoors and the global model is distributed to the participants for a next round of federated learning.

Most of the existing methods of defending against backdoor attacks through the federated learning take a centralized global perspective to determine which model updates are malicious. Since backdoor attacks do not significantly change the statistical characteristics of the model like Gaussian noise attacks, nor do they cause significant modifications to the training data like label flipping attacks, and they have less impact on the distribution of model parameters, they tend to be randomly scattered in space, making it difficult to separate the benign model updates from the malignant model updates from a global perspective. If the model updates are examined from a perspective of a certain model update, then the model update nearest to it may have the same purpose (i.e., if the model update is benign, then several model updates nearest to it are more likely to be benign), and both the benign model updates and the infected model updates are assumed to be want to exclude each other from an aggregation. Therefore, if each model update is assumed to be an intelligent agent with voting rights and votes for the model updates closest to it, then benign model updates may get more votes when the benign model updates are in the majority. Moreover, it is safer to include more benign model updates in the global model if the selected benign model updates are used as benign modes and benign model updates are gradually selected, because this gradual expansion way enables more and more benign modes to be referenced when screening benign model updates among the remaining candidate model updates.

The above description of examples is intended to facilitate the understanding and application of the present invention by an ordinary person skilled in the art, and it is obvious that a person familiar with the art can easily make various modifications to the above examples and apply the general principles described herein to other examples without creative labor. Therefore, the present invention is not limited to the above examples, and the improvements and modifications of the present invention made by a person skilled in the art according to the disclosure of the present invention shall be within the protection scope of the present invention.

What is claimed is:

1. A federated learning method against backdoor attacks, wherein in each round of federated learning, participants first download a global model from a central server, and then use a data set thereof to train and update parameters of a local global model, a parameter difference between an updated local global model and the global model originally downloaded in the round is a model update, and the participants then upload the model update to the central server, wherein:
after receiving N model updates, the central server selects, through a cluster-based voting mode, benign model updates from a decentralized perspective when the benign model updates are in the majority, wherein Nis a quantity of the participants in the federated learning;
a differential training set is constructed according to the selected benign model updates and the set is utilized to train a variational auto-encoder;
a differential verification set is constructed, data in the set is reconstructed by the variational auto-encoder, and a population of the selected benign model updates is progressively expanded according to a reconstruction error; and
the central server performs a federated average algorithm on all the selected benign model updates to obtain a global model without a backdoor and distributes the global model to the participants for a next round of federated learning.

2. The federated learning method according to claim 1, wherein the benign model updates refer to model updates obtained by the participants using a data set without an injected trigger for training, whereas model updates obtained by the participants using data set based on the injected trigger for training are malignant model updates.

3. The federated learning method according to claim 1, wherein a specific implementation of mining the benign model updates by the central server is as follows: first, a model update set received by the central server is denoted as [symbol] ={Δw₁, Δw₂, . . . , Δw_{N}}, wherein Δwᵢ is a model update uploaded by an i^{th} participant, and i is a natural number and 1≤i≤N; the global model is assumed as a neural network with L layers, and for an m^{th} layer parameter Δw_{i,m} in a model update Δwᵢ, a zero vector and K−1 model updates farthest from Δw_{i,m} are selected as initial points of a K-means algorithm, and Δw_{i,m} votes for all model updates in a cluster thereof after dividing into clusters, wherein m is a natural number and 1≤m≤L; in this way, each model update votes for L times, each with a weight of 1; and finally, several model updates with a highest vote form a benign model update set with high confidence, denoted as [symbol] .

4. The federated learning method according to claim 3, wherein after obtaining the set [symbol] , the central server first calculates differences between model updates in W according to a form of Cartesian product, thus forming a differential training set; any difference data in the differential training set is Δwₐ−Δw_{b}, wherein Δwₐ and Δw_{b} are any two different model updates in the set [symbol] ; and then the differential training set is utilized to train a variational autoencoder, of which an input is any difference data in the differential training set and an output is a vector of the same dimension, and the variational autoencoder can generate an output that is as similar as possible to the input.

5. The federated learning method according to claim 4, wherein a complementary set of the set [symbol] is taken, that is [symbol] − [symbol] ; any difference data in the differential verification set is Δw_{c}−Δw_{d}, wherein Δw_{c} is any model update in the complementary set, Δw_{d} is any model update in the set [symbol] ; the variational autoencoder is utilized to reconstruct each piece of difference data in the differential verification set; and several pieces of difference data with a least average reconstruction error are selected, and Δw_{c} in the pieces of difference data is added to the set [symbol] .

6. The federated learning method according to claim 5, wherein the reconstruction error is measured by a mean square error between input data of the variational autoencoder and reconstruction data.

7. The federated learning method according to claim 5, wherein when a population of benign model updates is expanded, a latest set [symbol] is utilized to update the differential training set and fine-tune the variational autoencoder for judgment; if the number of sets [symbol] exceeds a preset threshold, the federated averaging algorithm is performed on the sets; and otherwise, the differential verification set is updated with the latest set [symbol] , and the benign model updates are expanded again through reconstruction until the number of model updates contained in sets [symbol] exceeds the preset threshold.

8. The federated learning method according to claim 1, wherein the federated learning method does not rely on adjustment of differential privacy, weight clipping and a learning rate, and only a minor change is made to an original federated learning protocol, which on the one hand has little impact on the accuracy of the global model, and on the other hand is easy to integrate with an existing federated learning system; and moreover, the method, through cluster-based voting and progressive selection, may steadily select a group of benign model updates for aggregation without obvious clustering of benign and malignant model updates to different locations.
